(19) United States
(12) Patent Application Publication
(10) Pub. No.: US 2026/0251278 A1
(43) Pub. Date: Aug. 27, 2026

(54) LENS ASSEMBLY, OPTICAL LENS MODULE, AND VEHICLE LAMP

(71) Applicant: MIND ELECTRONICS APPLIANCE COMPANY LIMITED, Baoding (CN)

(72) Inventors: Zhiwang YUAN, Baoding (CN); Zhenren WANG, Baoding (CN); Xu YANG, Baoding (CN); Man PENG, Baoding (CN)

(73) Assignee: MIND ELECTRONICS APPLIANCE COMPANY LIMITED, Baoding (CN)

(21) Appl. No.: 19/649,433

(22) Filed: Apr. 16, 2026

Related U.S. Application Data
(63) Continuation of application No. PCT/CN2024/079190, filed on Feb. 29, 2024.

(30) Foreign Application Priority Data
Mar. 1, 2023 (CN) 202310187394.5
Mar. 1, 2023 (CN) 202310187410.0
Mar. 1, 2023 (CN) 202310187589.X

(51) Int. Cl. F21S 41/255; F21S 41/27

(52) U.S. Cl. CPC F21S 41/255; F21S 41/27

(57) ABSTRACT

An optical lens includes a lens assembly including a second lens and a third lens, and a real focal point of the lens assembly is located inside the second lens or outside the second lens. The optical lens may also include a first lens and a curved total reflection lens. A side of the first lens facing away from the third lens includes a light incident surface and a first inclined surface connected to each other. The curved total reflection lens is located below the first inclined surface and is convex on a side facing away from the first inclined surface. An external light enters through the light incident surface is reflected by the curved total reflection lens and the first inclined surface, then converges at a real focal point, and then is projected by the lens assembly into parallel light.

### CROSS-REFERENCE TO RELATED APPLICATIONS

The present application is a continuation of International Application No. PCT/CN2024/079190, which claims priority to Chinese Patent Application No. 202310187410.0, filed on March 1, 2023, Chinese Patent Application No. 202310187589.X, filed on March 1, 2023, and Chinese Patent Application No. 202310187394.5, filed on March 1, 2023. All of the aforementioned patent applications are hereby incorporated by reference in their entireties.

### TECHNICAL FIELD

The present application relates to the field of vehicle lamp technologies, and in particular, to a lens module, an optical lens module, and a vehicle lamp.

### BACKGROUND

With development of vehicle lamp lighting technologies, low beam and high beam lens modules for lighting have become increasingly popular, and a horizontal long strip module design has become one of the trends in the development of the industry. In the conventional technology, a solution with “a condenser and a single focal point focusing lens” is generally adopted to achieve this design.

However, in the traditional solution with “the condenser and the single focal point focusing lens”, generally, the high beam module is relatively long and has a relatively large volume in a direction along a vehicle body axis. Moreover, in the related single focal point focusing lens, in order to improve an illuminance of a high beam, a deflection angle of light from a non-central condenser is relatively large, thereby a color of a high beam pattern locally yellowing, and thus resulting in poor visual appearance.

At a same time, in the traditional solution with “the condenser and the single focal point focusing lens”, generally, the low beam module requires cooperation of a low beam cutoff line baffle. Moreover, a color of a low beam cutoff line in the traditional solution is poor and the low beam cutoff line has relatively severe dispersion.

In addition, a conventional single-layer single-focus lens is not suitable for designs with greater opening sizes or long strip openings, because once a horizontal opening is longer, a thickness of a lens will increase accordingly, and a weight thereof will also increase, which contradict to a concept of lightweight, energy saving and cost saving. Moreover, the conventional single-layer single-focus lens has same focused degrees in horizontal and vertical directions, resulting in poor controllability of low and high beams with a pattern which is flatter vertically and wider horizontally.

### SUMMARY

An objective of the present application is to provide a lens assembly, an optical lens module and a vehicle lamp, thereby solving problems that a conventional high beam lens module is relatively long and has a relatively large volume in a direction along a vehicle body axis, and a color of a high beam pattern locally yellowing, and thus resulting in poor visual appearance.

According to a first aspect of the present application, an optical lens module is provided. The optical lens module includes a first lens, a lens assembly and a curved total reflection lens. The lens assembly includes a second lens and a third lens. The second lens and the first lens are integrally formed. The third lens is disposed on a side of the second lens, and a real focal point of the lens assembly is located in the second lens. A side of the first lens facing away from the third lens includes a light incident surface and a first inclined surface connected to each other. The curved total reflection lens is disposed below the first inclined surface, and a side of the curved total reflection lens facing away from the first inclined surface is convex. A light emitted from an external light source is capable of entering through the light incident surface, being reflected by the curved total reflection lens and the first inclined surface, then converging at the real focal point, and then being projected by the lens assembly into a parallel light after passing through the real focal point.

In some embodiments, the lens assembly includes a plurality of the real focal points and a plurality of the curved total reflection lens. The plurality of curved total reflection lens are disposed below the first inclined surface, and the plurality of curved total reflection lens are in one-to-one correspondence with the plurality of real focal points. The light emitted from the external light source is capable of entering through the light incident surface, being reflected by the curved total reflection lens and the first inclined surface, then converging at the real focal point corresponding to the curved total reflection lens, and then being projected by the lens assembly into the parallel light after passing through the real focal point.

In some embodiments, a side of the second lens facing the third lens includes a plurality of convex portions. A convex surface of anyone of the plurality of convex portions is convex along an optical axis, anyone of the plurality of convex portions and the third lens collectively include one of the real focal points, and the plurality of convex portions are in one-to-one correspondence with the plurality of curved total reflection lenses. When observed along an optical axis direction, the light diverging from the real focal point remains parallel in a first direction after passing through a convex portion corresponding to the real focal point, and the optical axis direction is perpendicular to the first direction.

In some embodiments, a side surface of the third lens facing the second lens is concave along the optical axis. When observed along the optical axis direction, the light passing through the side surface of the third lens facing the second lens remains parallel in the first direction. A side surface of the third lens facing away from the second lens is convex along the optical axis. The light projected from the side surface of the third lens facing the second lens and passing through the side surface of the third lens facing away from the second lens is the parallel light.

In some embodiments, the first inclined surface is configured to mirror the curved total reflection lens into a virtual image, and a convergence point of the virtual image coincides with the real focal point of the lens assembly.

In some embodiments, the first lens further includes a second inclined surface, a third inclined surface and a vertical plane. The light incident surface, the first inclined surface, the third inclined surface, the second inclined surface and the vertical plane are sequentially connected. The light incident surface extends in a vertical direction, and the first inclined surface is at a first angle relative to the light incident surface and extends toward the second lens. The second inclined surface is at a third angle relative to the second inclined surface and extends toward the second lens. The third inclined surface is at a third angle relative to the second inclined surface and faces away from the first inclined surface at a third angle relative to the second inclined surface. The vertical plane is parallel to the light incident surface. An edge of anyone of the plurality of curved total reflection lenses is connected to the second inclined surface, the third inclined surface and the vertical plane.

In some embodiments, anyone of the plurality of curved total reflection lenses includes two sides opposite to each other and two curved edges opposite to each other. The two sides are both connected to the second inclined surface, the two curved edges are respectively connected to the third inclined surface and a vertical plane. The second lens further includes two side surfaces, the two side surfaces are opposite in each other in the first direction, and a curved edge is formed at a joint of an edge of anyone of the plurality of convex surfaces and the side surface corresponding to the edge of anyone of the plurality of convex surfaces.

In some embodiments, sizes of the light incident surface and vertical plane in the vertical direction are both greater than a size of the curved edge connected to the vertical plane in the vertical direction.

According to a second aspect of the present application, a vehicle lamp is provided, which includes the optical lens module as described in the first aspect above.

In some embodiments, the vehicle lamp further includes a plurality of light sources and a plurality of circuit boards, the plurality of light sources are in one-to-one correspondence with the plurality of circuit boards, the plurality of light sources are in one-to-one correspondence with the plurality of real focal point one by one, and a long side of anyone of the plurality of circuit boards extends in the vertical direction.

According to the optical lens module provided by the present application, the optical lens module includes the first lens, the lens assembly and the curved total reflection lens. The lens assembly includes the second lens and the third lens, and the second lens and the first lens are integrally formed. The third lens is disposed on a side of the second lens, and the real focal point of the lens assembly is located in the second lens. The side of first lens of the present application facing away from the third lens includes the light incident surface and the first inclined surface connected to each other. The curved total reflection lens is disposed below the first inclined surface, and the side of the curved total reflection lens facing away from the first inclined surface is convex. A light emitted from an external light source is capable of entering through the light incident surface, being reflected by curved total reflection lens and the first inclined surface, then converging at the real focal point, and then being projected by the lens assembly into the parallel light after passing through real focal point, that is, the real focus point of the lens assembly is located at a convergence point of the reflected light of the curved total reflection lens. An optical path of the present application is folded, so that a length of a module is shortened. Moreover, a final light pattern of the optical lens module (for a high beam) provided by the present application is an image of a light beam at the real focal point of the lens assembly, thus a brightness, color, and uniformity of a pattern of a high beam projected by the optical lens module of the present application are all good.

An objective of the present application is also to provide another optical lens module and a vehicle lamp, thereby solving the problems that conventional high and low beam lens modules are relatively long and has a relatively large volume in the direction along the vehicle body axis, and a color of a low beam cutoff line is poor and has severe dispersion.

According to a third aspect of the present application, an optical lens module is provided, which includes a first lens, a lens assembly and a curved total reflection lens. The lens assembly includes a second lens and a third lens, and the second lens and the first lens are integrally formed. The third lens is disposed on A side of the second lens, and a real focal point of the lens assembly is located outside the second lens. A side of the first lens facing away from the third lens includes a light incident surface and a first inclined surface connected to each other. The curved total reflection lens is disposed below the first inclined surface, and a side of the curved total reflection lens facing away from the first inclined surface is convex. A light emitted from an external light source is capable of entering through the light incident surface, being reflected by the curved total reflection lens, and then being reflected by the first inclined surface. The lens assembly is configured to project the light reflected by the first inclined surface into a parallel light.

In some embodiments, the optical lens module includes a plurality of the curved total reflection lenses. A side of the second lens facing the third lens includes a plurality of convex portions, a convex surface of anyone of the plurality of convex portions is convex along an optical axis, and the plurality of convex portions are in one-to-one correspondence with the plurality of curved total reflection lenses. The light emitted from an external light source is capable of entering through the light incident surface, being reflected by the corresponding curved total reflection lens, and then being reflected by the first inclined surface. When observed along an optical axis direction, the light reflected by first inclined surface remains parallel in a first direction after passing through the corresponding convex portion, and the optical axis direction is perpendicular to the first direction.

In some embodiments, a side surface of the third lens facing the second lens is concave along the optical axis. When observed along the optical axis direction, the light projected by anyone of the plurality of convex portions remains parallel in the first direction after passing through the side surface of the third lens facing the second lens. A side surface of the third lens facing away from the second lens is convex. The light projected by the side surface of the third lens facing the second lens and passing through the side surface of the third lens facing away from the second lens is the parallel light.

In some embodiments, the optical lens module includes a plurality of the curved total reflection lenses. The light emitted from the external light source is capable of entering through the light incident surface, being reflected by the plurality of curved total reflection lenses, and then being reflected by the first inclined surface. When observed along the optical axis direction, the light reflected by the first inclined surface remains parallel on a first direction after passing through a side surface of the second lens facing the third lens.

In some embodiments, a side surface of the third lens facing the second lens is concave along an optical axis. When observed along the optical axis direction, the light projected from the side surface of the second lens facing the third lens remains parallel in the first direction after passing through the side of the third lens facing the second lens. A side surface of the third lens facing away from the second lens is convex. The light projected from the side surface of the third lens facing the second lens and passing through the side surface of the third lens facing away from the second lens is the parallel light.

In some embodiments, the first lens further includes a second inclined surface, a third inclined surface and a fourth inclined surface. The light incident surface, the first inclined surface, the third inclined surface, the second inclined surface and the fourth inclined surface are sequentially connected. The light incident surface extends in a vertical direction. The first inclined surface is at a first angle relative to the light incident surface and extends towards the second lens. The fourth inclined surface is at a second angle relative to the light incident surface and extends toward the first inclined surface. The second inclined surface is at a third angle relative to the fourth inclined surface and extends toward the second lens. The third inclined surface is at a fourth angle relative to the second inclined surface and extends away from the first inclined surface. Anyone of the curved total reflection lenses includes two side edges and a curved edge connected to each other, the curved edge is connected to the third inclined surface. The two side edges are both connected to the fourth inclined surface. Widths of the two side edges gradually decreases from top to bottom.

In some embodiments, the first lens further includes a vertical plane, the vertical plane is connected to the fourth inclined surface, and the vertical plane is parallel to the light incident surface.

In some embodiments, the first inclined surface is configured to mirror the curved total reflection lens into a virtual image, and the real focal point of the lens assembly is located at an edge of the virtual image.

According to a fourth aspect of the present application, a vehicle lamp is provided, which includes the optical lens module as described in the third aspect.

In some embodiments, the vehicle lamp further includes a plurality of light sources and a plurality of circuit boards. The plurality of light sources are in one-to-one correspondence with the plurality of circuit boards, and the plurality of light sources are in one-to-one correspondence with plurality of curved total reflection lens. A long edge of anyone of the plurality of circuit boards extends in the vertical direction.

According to the present application, the optical lens module includes the first lens, the lens assembly and the curved total reflection lens. The lens assembly includes the second lens and the third lens, and the second lens and the first lens are integrally formed. The third lens is disposed on a side of the second lens, and the real focal point of the lens assembly is located outside the second lens. The side of the first lens facing away from the third lens includes the light incident surface and the first inclined surface connected to each other, the curved total reflection lens is disposed below the first inclined surface, and the side of the curved total reflection lens facing away from the first inclined surface is convex. A light emitted from an external light source of the present application is capable of entering through the light incident surface, being reflected by the curved total reflection lens and then being reflected by the first inclined surface. The lens assembly is configured project the light reflected by the first inclined surface into the parallel light, that is, the light reflected by the first inclined surface is projected into the parallel light by the lens assembly. An optical path of the present application is folded, so that a length of the module is shortened. Moreover, a final light pattern of the optical (low beam) lens module provided by the present application is an image of a light beam reflected by the curved total reflection lens, an edge of the curved total reflection lens is a boundary line forming a cutoff line of the low beam pattern. Compared to a traditional lens structure, the optical lens module of the present application forms a good cutoff line color, which is close to no dispersion.

An objective of the present application is also to provide a lens assembly, thereby solving problems that a conventional focusing lens is not suitable for designs with greater opening size or long strip openings and is in poor controllability of low and high beams with a pattern which is flatter vertically and wider horizontally.

According to a fifth aspect of the present application, a lens assembly is provided, the lens assembly includes a third lens and a second lens. The third lens is configured to converge a parallel light to a plurality of first focal points. The plurality of first focal points are on a first focal line. When observed along an optical axis direction, a light passing through the third lens remains parallel in a first direction. The second lens is disposed on a side of the third lens, and the second lens is configured to converge the light passing through the third lens to a plurality of second focal points, and the plurality of second focal points are on a second focal line. When observed along the optical axis direction, the light passing through the second lens is not parallel in the first direction.

In some embodiments, the first focal line and the second focal line are both parallel to the first direction, and the optical axis direction is perpendicular to the first direction.

In some embodiments, the second focal line is located in the second lens.

In some embodiments, the lens assembly includes a plurality of real focal points, and the plurality of second focal points coincide with the plurality of real focal points.

In some embodiments, a side of the second lens facing the third lens includes a plurality of convex portions, a convex surface of anyone of the plurality of convex portions is convex along the optical axis, and the convex surface and the third lens include one real focal point. The convex surface is configured to converge the light passing through the third lens to one second focal point;

In some embodiments, the second lens further includes an inclined surface opposite to the convex surface and two side surfaces located on two sides of the inclined surface, and a curved edge is formed at a joint of an edge of anyone of the convex surfaces and the side surface corresponding to the edge of the convex surface.

In some embodiments, a side surface of the third lens facing the second lens is concave along the optical axis, and a side surface of the third lens facing away from the second lens is convex along the optical axis.

According to a sixth aspect of the present application, a vehicle lamp is provided, which includes the lens module as described in the fifth aspect above.

In some embodiments, the vehicle lamp further includes a plurality of light sources and a first lens, the plurality of light sources are in one-to-one correspondence with the plurality of second focal points, and a light emitted from anyone of the plurality of light sources is capable of diverging by the corresponding second focal point after passing through the first lens.

In some embodiments, the first lens and the second lens are integrally formed.

According to the lens assembly of the present application, the lens assembly includes the third lens and the second lens. The third lens is configured to converge the parallel light to the plurality of first focal points, and the plurality of first focal points are on the first focal line. When observed along the optical axis direction, the light passing through the third lens remains parallel on the first direction. The second lens is disposed on a side of the third lens, and the second lens is configured to converge the light passing through the third lens to the plurality of second focal points, and the multiple second focal points are on the second focal line. When observed along the optical axis direction, the light passing through the second lens is not parallel in the first direction.

That is, the third lens of the present application only converges the light in the vertical direction, and the light remains parallel in the horizontal direction, that is, the plurality of first focal points converge on one focal line, the second lens converges the light horizontally, and a position of the focal point (the second focal point) is adjustable (for example, by adjusting a curvature, distance, or the like), and the plurality of second focal points converge on another focal line. Due to reversibility of the light, on-site personnel may install a plurality of light sources as needed, and the light emitted from anyone of the plurality of light sources diverges from the corresponding second focal point, and eventually diverges into the parallel light through the third lens. The vertical light of the present application has a longer focal length than the horizontal light (a distance from the second focal point to the side surface of the third lens facing away from the second lens, that is, a distance from the second focal point to the parallel light), which facilitates vertical convergence of the low and high beam patterns. The horizontal light of the present application has a shorter focal length than the vertical light (a distance from the second focal point to the side surface of the second lens facing the third lens, that is, a distance from the second focal point to the horizontal parallel light), which facilitates horizontal widening of the low and high light patterns, thereby design requirements are satisfied.

In addition, compared to a single-layer single focal point focusing lens in the conventional technologies, the present application uses two lenses to jointly complete a focusing, and an overall thickness is less than that of single focal point focusing lens, thereby reducing a weight.

In order to make the above objectives, features and advantages of the present application more obvious and easier to understand, preferred embodiments in detail with reference to the accompanying drawings will be specifically described below.

### BRIEF DESCRIPTION OF THE DRAWINGS

In order to more clearly illustrate the technical solutions of embodiments of the present application, the drawings required for the embodiments will be briefly introduced below. It should be understood that the following drawings only show some embodiments of the present application, and therefore should not be considered as limitations on the protection scope. For those skilled in the art, other related drawings can be obtained from these drawings without creative effort.

FIG. 1 is a side view of an optical path of an optical lens according to some embodiments of the present application.

FIG. 2 is a top view of an optical path of an optical lens according to some embodiments of the present application.

FIG. 3 is a schematic structural diagram of an integrated of a first lens and a second lens which are integrally formed according to some embodiments of the present application.

FIG. 4 is a schematic diagram of another perspective of FIG. 3.

FIG. 5 is a side view of FIG. 3.

FIG. 6 is a schematic structural diagram of a third lens according to some embodiments of the present application.

FIG. 7 is a schematic diagram of an overall structure of an optical lens module according to some embodiments of the present application.

FIG. 8 is a schematic structural diagram of a first lens and a second lens which are integrally formed according to some embodiments of the present application.

FIG. 9 is a schematic diagram of another perspective of FIG. 8.

FIG. 10 is a side view of FIG. 8.

FIG. 11 is a schematic structural diagram of a third lens according to some embodiments of the present application.

FIG. 12 is a side view of an optical path of an optical lens module according to some embodiments of the present application.

FIG. 13 is a top view of an optical path of an optical lens module according to some embodiments of the present application.

FIG. 14 is a schematic diagram of yet another perspective of FIG. 8.

FIG. 15 is a schematic diagram of an overall structure of an optical lens module according to some embodiments of the present application.

FIG. 16 is a schematic structural diagram of a first lens and a second lens which are integrally formed according to some embodiments of the present application.

FIG. 17 is a schematic diagram of another angle of FIG. 16.

FIG. 18 is a side view of FIG. 16.

FIG. 19 is a schematic structural diagram of a third lens according to some embodiments of the present application.

FIG. 20 is a side view of an optical path of an optical lens module according to some embodiments of the present application.

FIG. 21 is a top view of an optical path of an optical lens module according to some embodiments of the present application.

FIG. 22 is a schematic diagram of yet another perspective of FIG. 16.

FIG. 23 is a side view of an optical path of the main light of an optical lens module according to some embodiments of the present application.

FIG. 24 is a side view of a lens assembly and an optical path according to some embodiments of the present application.

FIG. 25 is a top view of a lens assembly and an optical path according to some embodiments of the present application.

FIG. 26 is an oblique view of a third lens and am optical path of a first example of some embodiments of the present application.

FIG. 27 is an oblique view of a third lens and an optical path of a second example of a sixth embodiment of the present application.

FIG. 28 is a side view of a third lens and an optical path according to some embodiments of the present application.

FIG. 29 is a top view of a third lens and an optical path according to some embodiments of the present application.

FIG. 30 is a schematic diagram of an overall structure of a lens assembly according to some embodiments of the present application.

### DETAILED DESCRIPTION OF THE EMBODIMENTS

The technical solution of the present application will be described clearly and completely below with reference to the accompanying drawings. Obviously, the described embodiments are a portion of the embodiments of the present application, rather than all of the embodiments. Based on the embodiments in the present application, all other embodiments obtained by those with ordinary skill in the art without creative work shill fall within the protection scope of the present application.

In the description of the present application, it should be noted that the orientation or positional relationship indicated by the terms “center”, “upper”, “lower”, 'left”, “right”, “vertical”, “horizontal”, “inner”, “outer”, and the like is based on the orientation or positional relationship shown in the drawings, and is only for the convenience of describing the present application and simplifying the description, rather than indicating or implying that the device or element referred to must have a specific orientation, and be constructed and operated in a specific orientation, and therefore, it should not be understood as a limitation on the present application. In addition, the terms “first”, “second”, “third”, and the like, are only used for descriptive purposes and should not be understood as indicating or implying relative importance.

In the description of the present application, it should be noted that unless otherwise clearly specified and defined, the terms “install”, “connect”, “concatenate”, and the like should be understood broadly. For example, they may be fixed connection, detachable connection, or integral connection; they may be mechanical connection or electrical connection; they may be direct connection or indirect connection through an intermediate medium, and they may be internal connection between two elements. For those with ordinary skill in the art, the specific meanings of the above terms in the present application may be understood according to the specific situation.

In addition, the technical solutions of various embodiments may be combined with each other, but they must be based on that those with ordinary skill in the art can implement them. When the combination of technical solutions results in mutual contradictory or impossible to be implemented, it should be considered that such a combination of technical solutions does not exist, and it will not fall within the protection scope claimed by the present application.

According to a first aspect of the present application, an optical lens module is provided, which solves problems that a conventional high beam lens module is relatively long and has a relatively large volume r in a direction along a vehicle body axis, and a color of a high beam pattern is locally yellowish, resulting in poor visual appearance.

With development of vehicle lamp lighting technologies, high and low beam lens modules for lighting have become increasingly popular. However, in the traditional solution with “a condenser and a single focal point focusing lens”, generally, the high beam module is relatively long and has a relatively large volume in a direction along a vehicle body axis.

Before the present application is put forward, in conventional single-focus lenses, the high beam module required a greater light deflection angle for a non-central condenser to improve high beam illuminance, resulting in a color of a high beam pattern is locally yellowish, thereby causing poor appearance.

In view of this, according to a first aspect of the present application, an optical lens module is provided, which includes a first lens 100, a lens assembly and a curved total reflection lens 700. The lens assembly includes a second lens 200 and a third lens 300. The second lens 200 and first lens 100 are integrally formed, the third lens 300 is disposed on a side of the second lens 200, and a real focal point 400 of the lens assembly is located in the second lens 200. A side of the first lens 100 facing away from the third lens 300 includes a light incident surface 101 and a first inclined surface 102 connected to each other, and the curved total reflection lens 700 is disposed below the first inclined surface 102. A side of the curved total reflection lens 700 facing away from the first inclined surface 102 is convex. A light emitted from an external light source 500 is capable of entering through the light incident surface 101, being reflected by the curved total reflection lens 700 and the first inclined surface 102, then converging at the real focal point 400, and then being projected by the lens assembly into parallel light after passing through the real focal point 400, that is, the real focus 400 of the lens assembly is located at a convergence point of the reflected light of the curved total reflection lens 700. An optical path of the present application is folded, so that a length of a module is shortened. Moreover, a final light pattern of the optical lens module (high beam) provided by the present application is an image of a light beam at the real focal point 400 of the lens assembly, so that a brightness, color, and uniformity of a pattern of the high beam projected by the optical lens module of the present application are all good. Specific structures of the first lens 100, the lens assembly and the curved total reflection lens 700 will be described in detail below.

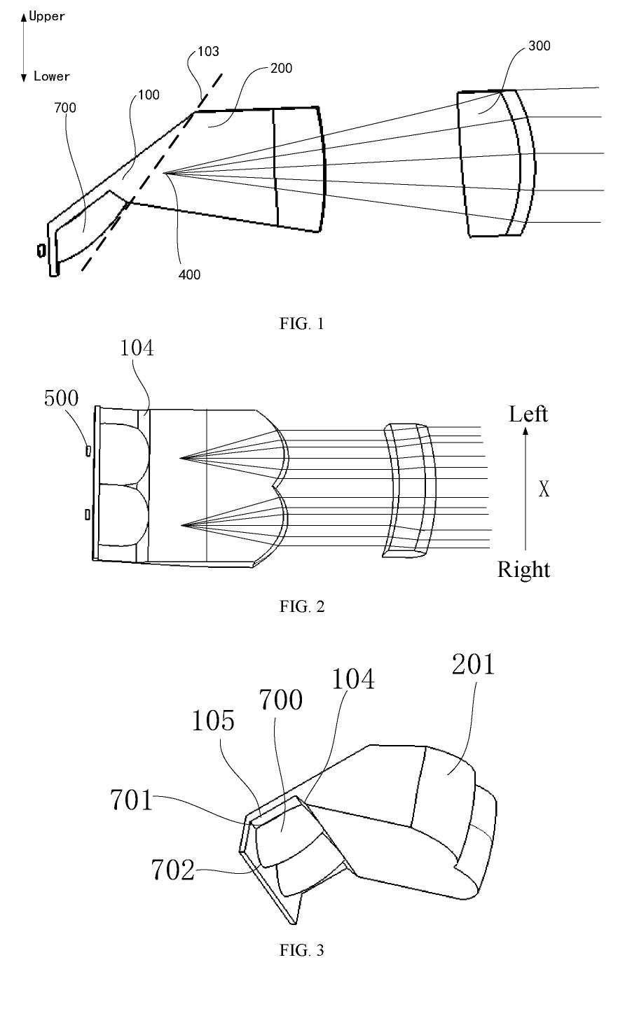

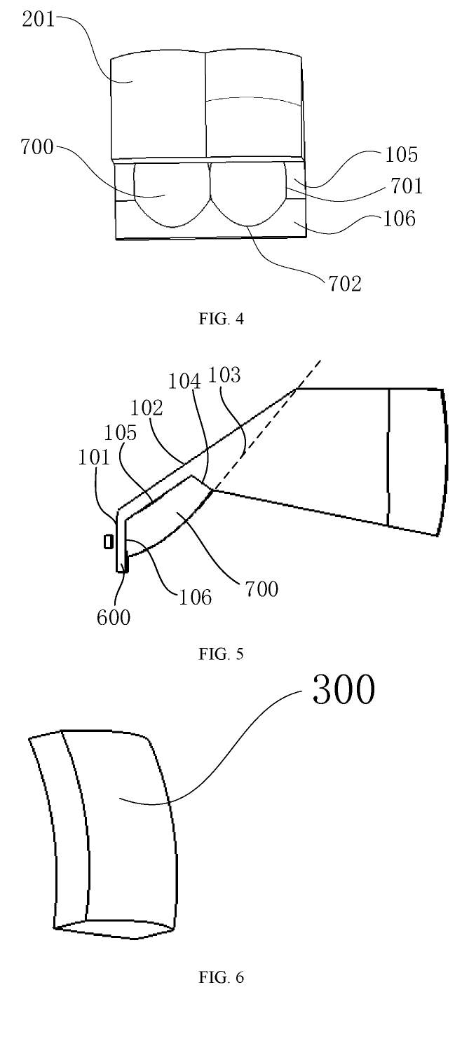

In the embodiments of the present application, as shown in FIG. 1 to FIG. 5, the lens assembly includes a plurality of the real focal point 400 and a plurality of the curved total reflection lens 700. The plurality of curved total reflection lens 700 are all disposed below the first inclined surface 102, and the plurality of curved total reflection lens 700 are in one-to-one correspondence with the plurality of real focal point 400. The light emitted from the light source 500 is capable of entering through the light incident surface 101, being reflected by the curved total reflection lens 700 and the first inclined surface 102, then converging at the real focal point 400 corresponding to the curved total reflection lens 700, and then being projected by the lens assembly into the parallel light after passing through the real focal point 400.

As an example, as shown in FIG. 2 to FIG. 4, a side of the second lens 200 facing the third lens 300 includes a plurality of convex portions 201, a convex surface of anyone of the plurality of convex portions 201 is convex along an optical axis, and anyone of plurality of the convex portions 201 and the third lens 300 include one of the real focal points 400. When observed along an optical axis direction (the optical axis direction is perpendicular to a first direction X), a light diverging from the real focal point 400 remains parallel in the first direction X after passing through the convex portion 201 corresponding to the real focal point 400, that is, it is not parallel in a vertical direction but remains parallel in a horizontal direction. According to reversibility of light, that is, the convex surface of anyone of the convex portions 201 and the third lens 300 include the real focal point 400. Herein, the description that a surface of the lens is convex along the optical axis means that a paraxial region of the corresponding surface is convex. Therefore, even when a surface of a lens is described as being convex, an edge portion of the surface of the lens may be concave.

In addition, as shown in FIG. 3, the second lens 200 also includes a connecting virtual surface (the connecting virtual surface is connected to a virtual surface 103 of the first lens 100) and two side surfaces located on two sides of the connecting virtual surface. The first direction X is capable of passing through the two side surfaces, and a curved edge (edge line) is formed at a joint of an edge of anyone of the convex surface and the corresponding side surface. Herein, curvatures of the two curved edges may be set according to requirements.

In the embodiments of the present application, as shown in FIG. 1, FIG. 2, and FIG. 6, a side surface of the third lens 300 facing the second lens 200 is concave along the optical axis. When observed along the optical axis direction, the light projected by anyone of the plurality of the convex portions 201 remains parallel in the first direction X after passing through the side surface of the third lens 300 facing the second lens 200, that is, it remains parallel in the horizontal direction, but it is not parallel in the vertical direction. A side surface of the third lens 300 facing away from the second lens 200 is convex. The light projected from the side surface of the third lens 300 facing the second lens 200 is the parallel light after passing through the side surface of the third lens 300 facing away from the second lens 200.

According to the reversibility of light, as shown in FIG. 1, FIG. 2 and FIG. 25 to FIG. 29, the parallel light is capable of converging into a plurality of first focal points 111 by the third lens 300, and the plurality of first focal points 111 are on a first focal line 110. When observed along the optical axis direction, the light passing through the third lens 300 remains parallel in the first direction X (that is, when viewed from top). The second lens 200 is disposed on a side of the third lens 300, and the light passing through the third lens 300 is capable of converging into a plurality of second focal points 211 (that is, the real focal point 400 of the lens assembly) by the second lens 200, and the plurality of second focal points 211 are located on a second focal line. When observed along the optical axis direction, the light passing through the second lens 200 is not parallel in the first direction X.

That is, the third lens 300 of the present application only focuses the light in the vertical direction, while the light in the horizontal direction remains parallel, which means that the plurality of first focal points 111 converge on one focal line. The second lens 200 focuses horizontally, and the focal point is the real focal point 400 of the lens assembly, and the plurality of second focal points 211 converge on another focal line. A vertical light of the present application has a greater focal length compared to a horizontal light (as shown in FIG. 1, a distance from the real focal point 400 to the side surface of the third lens 300 facing away from the second lens 200, that is, a distance from the light source to the parallel light), which facilitates the vertical convergence of high and low beam patterns. The horizontal light of the present application has a shorter focal length compared to the vertical light (as shown in FIG. 2, a distance from the real focal point 400 to the side surface of the second lens 200 facing the third lens 300, that is, a distance from the light source to the horizontal parallel light), which facilitates a horizontal widening while maintaining vertical narrowness of the high and low beam patterns, making the high beam pattern be flat and wide, thereby meeting requirements of the high and low beam patterns. In addition, compared to a single-layer single focal point focusing lens in the conventional technologies, the present application adopts two lenses (the second lens 200 and the third lens 300) to achieve focusing, so that an overall thickness is less than the single focal point focusing lens, thereby reducing a weight.

Herein, the first inclined surface 102 is capable of mirroring the curved total reflection lens 700 into a virtual image, and a convergence point of the virtual image coincides with the real focal point 400 of the lens assembly. That is, in the absence of the mirroring effect of the first inclined surface 102, the convergence point of the curved total reflection lens 700 coincides with the real focal point 400 of the lens assembly. In a case that the curved total reflection lens 700 is mirrored into the virtual image, it is equivalent to that the convergence point of the virtual image coincides with the real focal point 400 of the lens assembly. Therefore, a brightness, color, and uniformity of the high beam pattern projected by the optical lens module are all good.

In the embodiments of the present application, as shown in FIG. 5, the first lens 100 also includes a second inclined surface 105, a third inclined surface 104 and a vertical plane 106, and the light incident surface 101, the first inclined surface 102, the third inclined surface 104, the second inclined surface 105 and the vertical plane 106 are sequentially connected. The light incident surface 101 extends in the vertical direction. The first inclined surface 102 is at a first angle relative to the light incident surface 101 and extends toward the second lens 200. The second inclined surface 105 is at a second angle relative to the light incident surface 101 and extends toward the second lens 200. The third inclined surface 104 is at a third angle relative to the second inclined surface 105 and extends away from the first inclined surface 102. The vertical plane 106 is parallel to the light incident surface 101, and the second inclined surface 105 is parallel to the third inclined surface 104. An edge of anyone of the plurality of curved total reflection lenses 700 is connected to the second inclined surface 105, the third inclined surface 104 and the vertical plane 106.

As an example, referring to FIG. 3 to FIG. 5, anyone of the plurality of curved total reflection lenses 700 includes two side edges 701 opposite to each other and two curved edges 702 opposite to each other. The two side edges 701 are both connected to the second inclined surface 105, and the two curved edges 702 are connected to the third inclined surface 104 and the vertical plane 106, respectively.

It is worth to be mentioned herein that, the first lens 100 and the second lens 200 may be integrally formed. Herein, to illustrate the lens assembly (the second lens 200 and the third lens 300), as shown in FIG. 1 and FIG. 5, the first lens 100 and the second lens 200 integrally formed are divided by the virtual surface 103, which does not actually exist.

In addition, a beam formed by a traditional 'condenser + single focal point focusing lens' module will present a circular condenser-like light spot image on a surface of a vehicle headlight cover, this defect has been complained about by many manufacturers.

A structure of the curved total reflection lens of the present application mentioned above is regular and complete, with neat and orderly edge lines. Therefore, uniformity of a light spot on a headlight cover is good, so that an appearance is good, and thus customer satisfaction is improved.

In addition, as shown in FIG. 3 to FIG. 5, sizes of the light incident surface 101 and the vertical plane 106 in the vertical direction are both greater than a size of the curved edges 702 connected to the vertical plane 106 in vertical direction, that is, a light baffle flange 600 formed by extension of the bottom of the light incident surface 101 and the vertical plane 106, and the light baffle flange 600 is used for cooperating with the second inclined surface 105 to reduce generation of stray light by projecting the excess stray light onto the ground.

In addition, since the third lens 300 of the present application is not a single focus point lens, this module design may avoid focusing the sunlight into a point or a cluster, which greatly reduces a risk that the sunlight burns a part of a vehicle lamp.

According to a second aspect of the present application, a vehicle lamp is provided, which includes the optical lens module as described in the first embodiment.

In addition, the vehicle lamp also includes a plurality of light sources 500 and a plurality of circuit boards. The plurality of light sources 500 are in one-to-one correspondence with the plurality of circuit boards, and the plurality of light sources 500 are in one-to-one correspondence with the plurality of the real focal points 400. A long edge of anyone of the plurality of circuit boards extends in the vertical direction, that is, the circuit boards are vertically placed and faces the optical axis direction. This layout ensures good thermal cycling of the module, which is beneficial for heat dissipation and is convenient for installation.

According to the optical lens module of the present application, the optical lens module includes the first lens 100, the lens assembly and the curved total reflection lens 700. The lens assembly includes the second lens 200 and the third lens 300, and the second lens 200 and the first lens 100 are integrally formed. The third lens 300 is disposed on a side of the second lens 200, and the real focal point 400 of the lens assembly is located in the second lens 200. A side of the first lens 100 of the present application facing away from the third lens 300 includes the light incident surface 101 and the first inclined surface 102 connected to each other. The curved total reflection lens 700 is disposed below the first inclined surface 102, and the side of the curved total reflection lens 700 facing away from the first inclined surface 102 is convex. The light emitted from the external light source is capable of entering through the light incident surface 101, being reflected by the curved total reflection lens 700 and the first inclined surface 102, then converging at the real focal point 400, and then then being projected by the lens assembly into the parallel light after passing through the real focal point 400, that is, the real focus point 400 of the lens assembly is located at the convergence point of the reflected light of the curved total reflection lens 700. The optical path of the present application is folded, so that a length of the module is shortened. Moreover, a final light pattern of the optical lens module (high beam) provided by the present application is an image of the light beam at the real focal point 400 of the lens assembly, thus the brightness, color and uniformity of the high beam pattern projected by optical lens module of the present application are all good.

The third aspect of the present application provides an optical lens module, which solves problems that conventional high and low beam lens modules is relatively long and has a relatively large volume in a direction along a vehicle body axis, and a low beam cutoff line has poor color and severe dispersion.

Before the present application is put forward, in a traditional solution with “a condenser and a single focal point focusing lens”, generally, a low beam module is relatively long and has a relatively large volume in the direction along the vehicle body axis, and requires cooperation of a low beam cutoff line baffle. Moreover, a color of a low beam cutoff line in the traditional solution is poor and the low beam cutoff line has relatively severe dispersion.

In view of this, according to a third aspect of the present application, an optical lens module is provided, which includes a first lens 100, a lens assembly and a curved total reflection lens 700. The lens assembly includes a second lens 200 and a third lens 300, and the second lens 200 and first lens 100 are integrally formed. The third lens 300 is disposed on a side of the second lens 200, and a real focal point 400 of the lens assembly is located outside the second lens 200. A side of the first lens 100 facing away from the third lens 300 includes a light incident surface 101 and a first inclined surface 102 connected to each other. The curved total reflection lens 700 is disposed below the first inclined surface 102, and the side of the curved total reflection lens 700 facing away from the first inclined surface 102 is convex. A light emitted from an external light source 500 of the present application is capable of entering through the light incident surface 101, being reflected by the curved total reflection lens 700, and then being reflected by the first inclined surface 102. The lens assembly projects the light reflected by the first inclined surface 102 into parallel light, that is, the light reflected by the first inclined surface 102 is projected into the parallel light by the lens assembly. An optical path of the present application is folded, so that a module length is shortened and a module volume is reduced. Moreover, a final light pattern of the optical (low beam) lens module provided by the present application is an image of a beam reflected by the curved total reflection lens 700, and the edge of the curved total reflection lens 700 is a boundary line forming a cutoff line of a low beam pattern. Compared to a traditional lens structure, the present application may form a good cutoff line color, which is close to no dispersion. Specific structures and optical paths of the first lens 100, the lens assembly and curved total reflection lens 700 will be described in detail below.

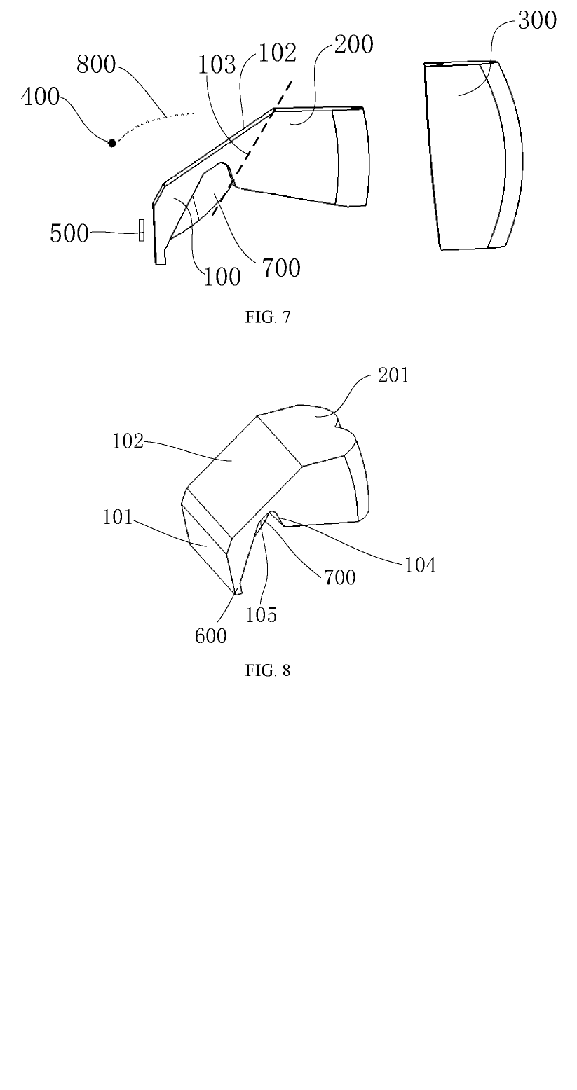

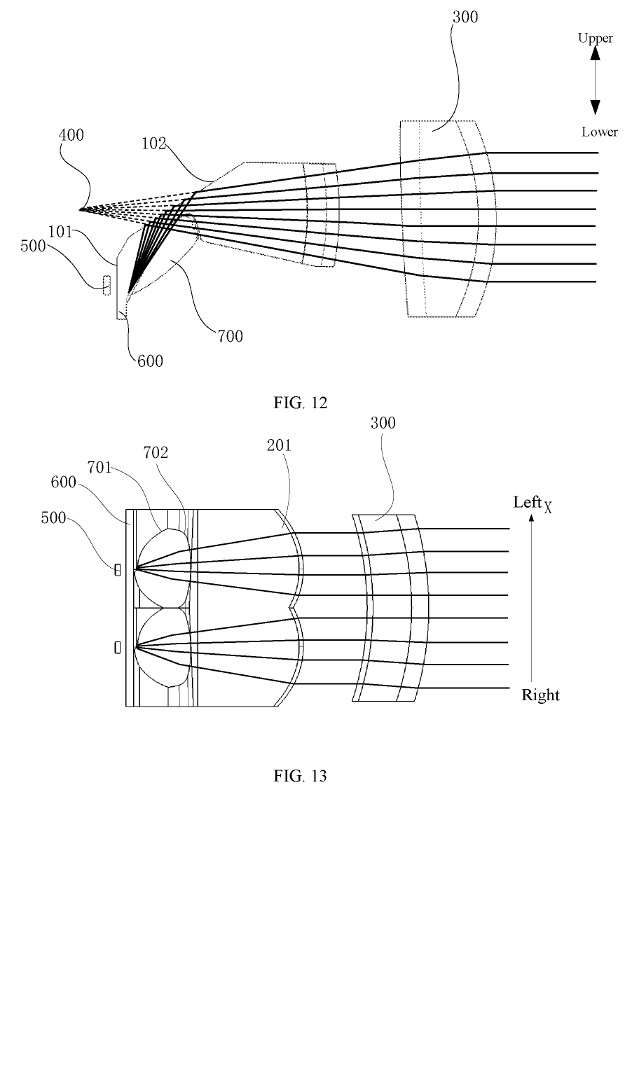

In the embodiment of the present application, as shown in FIG. 7 to FIG. 14, the optical lens module may include a plurality of the curved total reflection lens 700. A side of the second lens 200 facing the third lens 300 includes a plurality of convex portions 201, a convex surface of anyone of the plurality of convex portions 201 is convex along an optical axis, and the plurality of convex portions 201 are in one-to-one correspondence with the plurality of curved total reflection lens 700. As shown in FIG. 12 and FIG. 13, the light emitted from the external light source 500 is capable of entering through the light incident surface 101, being reflected by a corresponding curved total reflection lens 700, and then being reflected by the first inclined surface 102. The light reflected by the first inclined surface 102 remains parallel in a first direction X after passing through the corresponding convex portion 201, that is, it remains parallel in a horizontal direction, but it is not parallel in a vertical direction. According to reversibility of light, anyone of the plurality of convex surfaces and the third lens 300 include the real focal point 400. Herein, the description that a surface of a lens is convex along the optical axis means that a paraxial region of the corresponding surface is convex. Therefore, even when the surface of the lens is described as being convex, an edge portion of the surface of the lens may be concave.

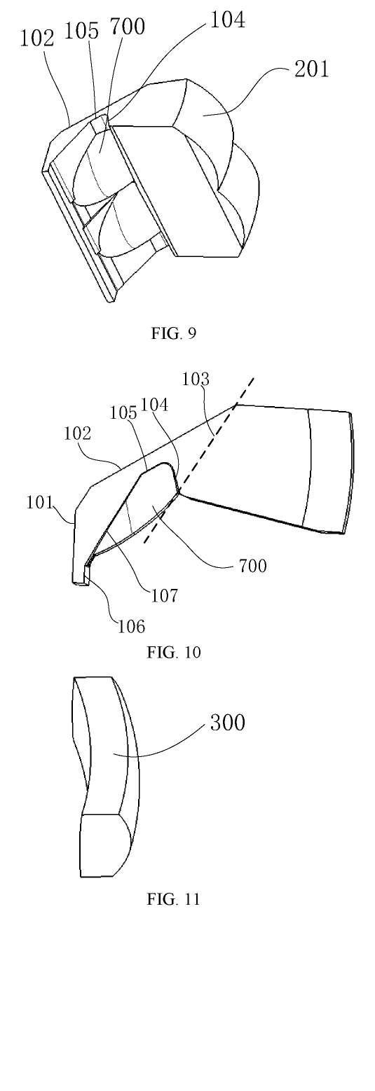

In addition, as shown in FIG. 8 and FIG. 9, the second lens 200 also includes a connecting virtual surface (the connecting virtual surface is connected to a virtual surface 103 of the first lens 100) and two side surfaces located on two sides of the connecting virtual surface. A curved edge is formed at a joint of an edge of anyone of the plurality of convex surfaces and the corresponding side surface. Herein, curvatures of the two curved edges may be set according to requirements.

In the third embodiment of the present application, as shown in FIG. 11 to FIG. 13, a side surface of the third lens 300 facing the second lens 200 is concave along the optical axis. When observed along the optical axis, the optical axis direction is perpendicular to the first direction X. The light projected from anyone of the c convex portions 201 remains parallel in the first direction X after passing through the side surface of the third lens 300 facing the second lens 200, that is, it is parallel in a horizontal direction, but it is not parallel in a vertical direction. A side surface of the third lens 300 facing away from the second lens 200 is convex. The light projected from the side surface of the third lens 300 facing the second lens 200 is the parallel light after passing through the side surface of the third lens 300 facing away from the second lens 200.

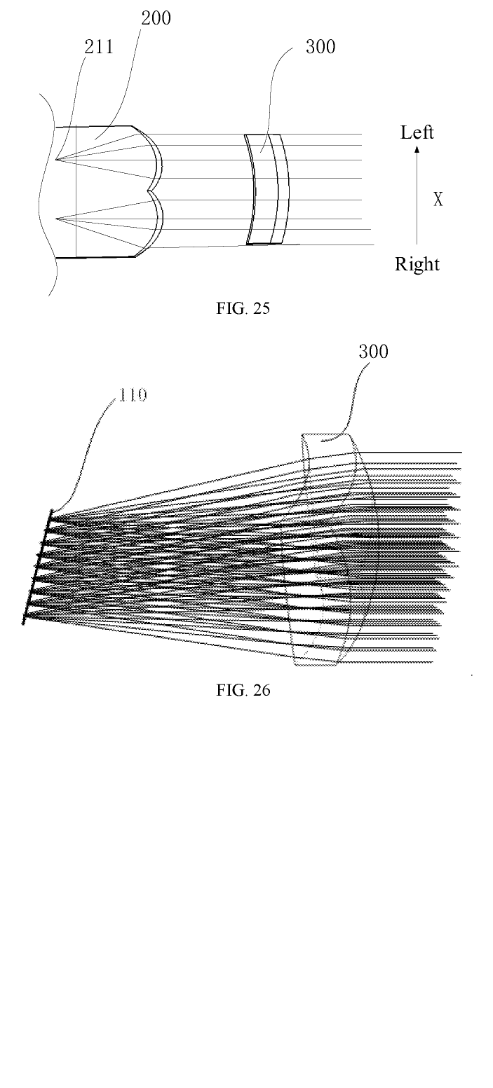

According to the reversibility of light, as shown in FIG. 12, FIG. 13, FIG. 25 and FIG. 29, the third lens 300 is capable of converging the parallel light into a plurality of first focal points 111 which are located on a first focal line 110. When observed along the optical axis direction, the light passing through the third lens 300 remains parallel in the first direction X (that is, when viewed from top). The second lens 200 is placed on a side of the third lens 300, and the second lens 200 is capable of converging a light passing through the third lens 300 into a plurality of second focal points 211 (that is, the real focal point 400 of the lens assembly) which are located on a second focal line. When observed along the optical axis direction, the light passing through the second lens 200 is not parallel on the first direction X.

That is, the third lens 300 in the present application only focuses in the vertical direction, while the light remains parallel in the horizontal direction, that is, the plurality of first focal points 111 converge on one focal line. The second lens 200 focuses in the vertical direction, the focal point is the real focal point 400 of the lens assembly (external), and the plurality of second focal points 211 converge on another focal line. A vertical light in the present application has a greater focal length compared to a horizontal light (as shown in FIG. 12, a distance from the light source to the side surface of the third lens 300 facing away from the second lens 200, that is, a distance from the light source to the parallel light), which facilitates vertical convergence of high and low beam patterns. The horizontal light in the present application has a shorter focal length compared to the vertical light (as shown in FIG. 13, a distance from the light source to the side surface of the second lens 200 facing the third lens 300, that is, a distance from the light source to the left-right parallel light), which facilitates horizontal widening and vertical narrowness of the high and low beam light patterns, thereby satisfying requirements of the high and low beam patterns. In addition, compared to the single-layer single focal point focusing lens in the conventional technologies, the present application adopts two lenses (the second lens 200 and the third lens 300) to achieve focusing, so that an overall thickness is less than the single focal point focusing lens, thereby reducing a weight thereof.

Herein, the first inclined surface 102 mirrors the curved total reflection lens 700 into a virtual image 800. The plurality of real focal points 400 (that is, the focal line) of the lens assembly are located at an edge of the virtual image 800, that is, near a boundary of the virtual image 800, which forms a good light pattern, and the cutoff line has good color, which is close to no dispersion.

In the third embodiment of the present application, as shown in FIG. 9 and FIG. 10, the first lens 100 also includes a second inclined surface 105, a third inclined surface 104 and a fourth inclined surface 107, and the light incident surface 101, the first inclined surface 102, the third inclined surface 104, the second inclined surface 105 and the fourth inclined surface 107 are sequentially connected. The light incident surface 101 extends in a vertical direction. The first inclined surface 102 is at a first angle relative to the light incident surface 101 and extends toward the second lens 200. The fourth inclined surface 107 is at a second angle relative to the light incident surface 101 and extends toward the first inclined surface 102. The second inclined surface 105 is at a third angle relative to the fourth inclined surface 107 and extends toward the second lens 200. The third inclined surface 104 is at a fourth angle relative to the second inclined surface 105 and extends away from the first inclined surface 102.

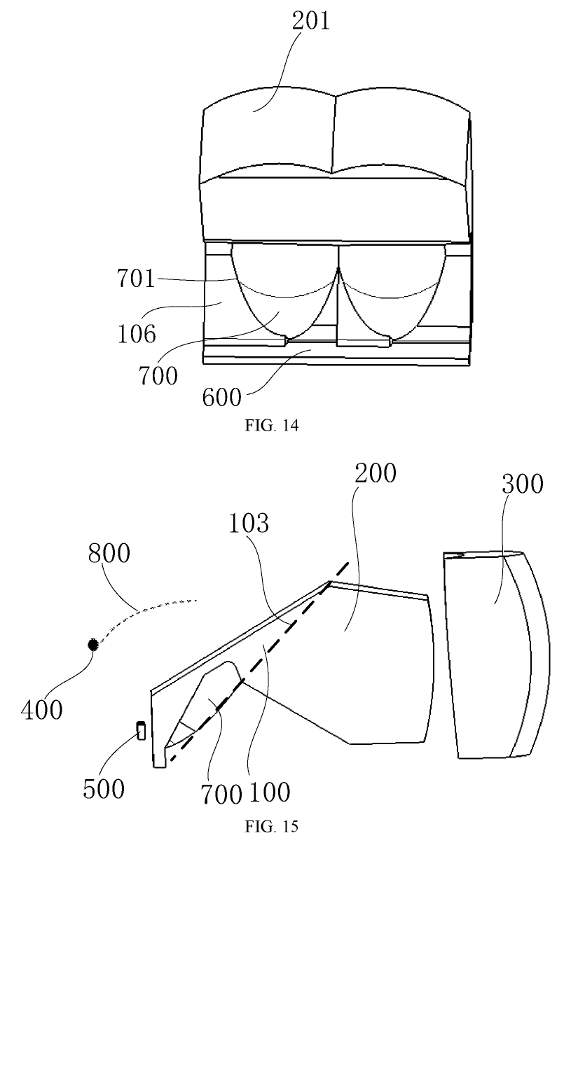

As an example, as shown in FIG. 9, FIG. 13, and FIG. 14, anyone of the plurality of curved total reflection lenses 700 includes two side edges 701 (also called arc edges) and a curved edge 702 connected to each other. The curved edge 702 is connected to the third inclined surface 104, and two side edges 701 are both connected to the fourth inclined surface 107. Widths of the two side edges 701 gradually decreases from top to bottom. In addition, the curved total reflection lens 700 may also include two straight edges, anyone straight edge is connected to the second inclined surface 105 and is connected between the curved edge 702 and one of the side edges 701.

It is worth to be mentioned herein that, the first lens 100 and the second lens 200 may be integrally formed. To illustrate the lens assembly (the second lens 200 and the third lens 300), as shown in FIG. 7 and FIG. 10, the first lens 100 and the second lens 200 integrally formed are divided by a virtual surface 103 which does not actually exist.

In addition, a traditional module with “a condenser and a single focal point focusing lens” forms a beam that presents a circular condenser-like spot image on a surface of a vehicle headlight cover, and this defect is complained about by many manufacturers.

A structure of the curved total reflection lens 700 in the present application mentioned above is complete and regular, with neat and orderly edge lines. Therefore, uniformity of a light spot on a headlight cover is good, so that an appearance is good, and thus customer satisfaction is improved.

In the embodiment of the present application, as shown in FIG. 7 to FIG. 10, the first lens 100 may also include a vertical plane 106, and the vertical plane 106 is connected to the fourth inclined surface 107 and is parallel to the light incident surface 101, that is, the light incident surface 101 and the vertical plane 106 form a light baffle flange 600. The light baffle flange 600 is configured to cooperate with the fourth inclined surface 107 to reduce generation of stray light by projecting the excess stray light onto the ground.

In addition, since the third lens 300 of the present application is not a single focus point lens, the solution of the module may avoid focusing the sunlight into a point or a cluster, which greatly reduces a risk that the sunlight burns a part of a vehicle lamp.

In addition, it is worth to be mentioned that, as shown in FIG. 23, a solid line in FIG. 23 represents the light affecting the cutoff line, and a dotted line represents the main light. That is, a middle portion of the curved total reflection lens 700 affects the light at the bottom of the final light pattern, and the light at the edge of the curved total reflection lens 700 affects the parallel light in a middle portion of the final light pattern, that is, it affects a shape of the final light pattern.

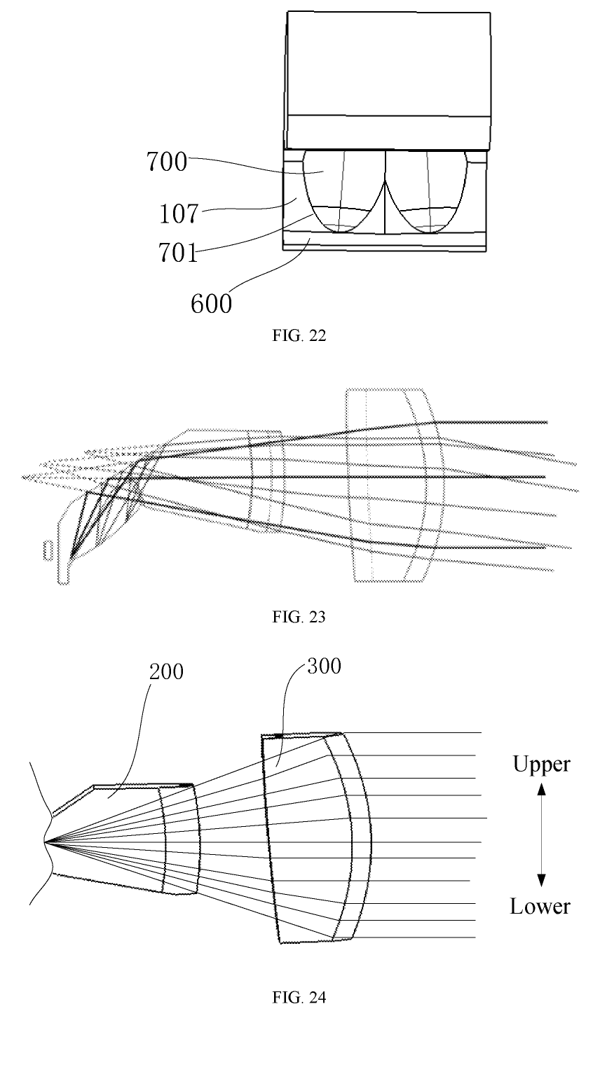

Different from the embodiments of the optical lens module of the present application mentioned above, in an alternative embodiment, as shown in FIG. 15 to FIG. 22, an optical lens module may include a plurality of curved total reflection lenses 700. As shown in FIG. 20 and FIG. 21, a light emitted from an external light source 500 is capable of entering through a light incident surface 101, being reflected by the curved total reflection lens 700, and then being reflected by the first inclined surface 102. The light reflected by the first inclined surface 102 remains parallel in the first direction X after passing through the side surface of the second lens 200 facing the third lens 300. That is, the originally parallel light in a horizontal direction remains parallel in the horizontal direction after passing through the side surface of the second lens 200 facing the third lens 300, but it is not parallel in the vertical direction. According to the reversibility of light, the side surface of the second lens 200 facing the third lens 300 and the third lens 300 includes a plurality of the real focal points 400.

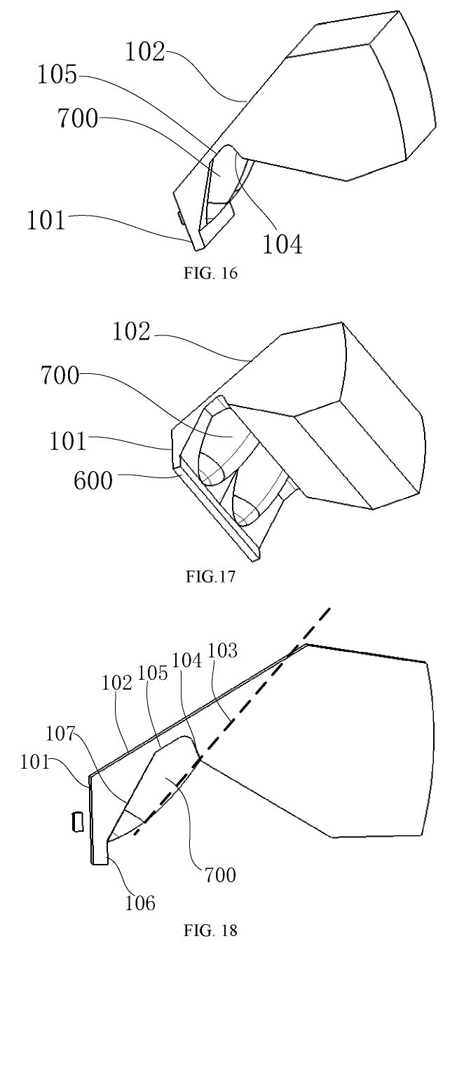

In addition, as shown in FIG. 16 and FIG. 17, the second lens 200 also includes a connecting virtual surface (the connecting virtual surface connected to a virtual surface 103 of a first lens 100) and two side surfaces on two sides thereof. Herein, a curvature of the side surface of the second lens 200 facing the third lens 300 may be set according to requirements, which is beneficial for increasing a width of the light pattern.

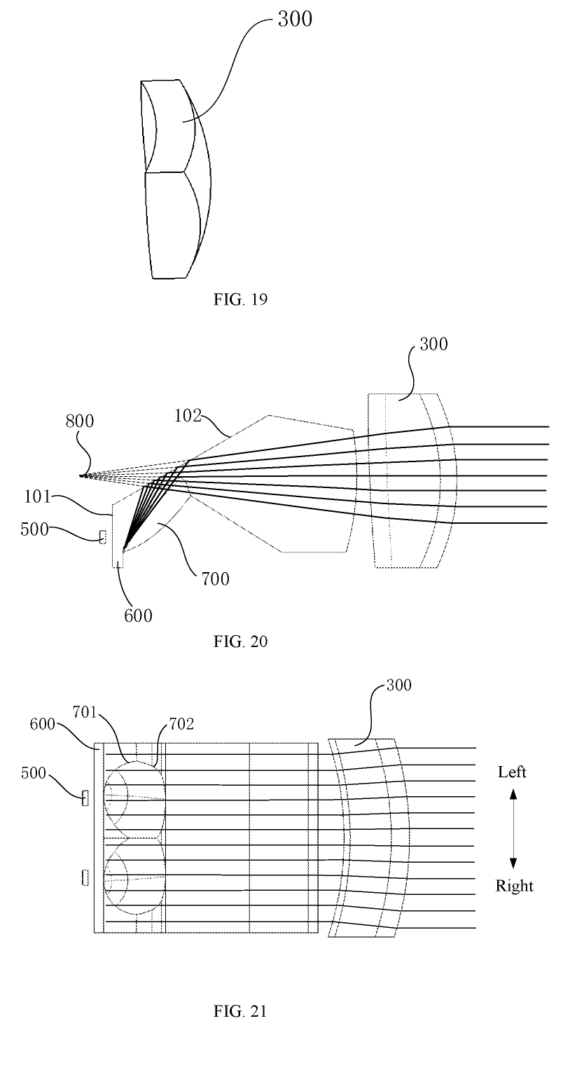

In the embodiment of the present application, as shown in FIG. 19 to FIG. 21, a side surface of the third lens 300 facing the second lens 200 is concave along the optical axis. The light projected from the side surface of the second lens 200 facing the third lens 300 remains parallel in the first direction X after passing through the side surface of the third lens 300 facing the second lens 200, that is, it is parallel in the horizontal direction, but it is not parallel in the vertical direction. A side surface of the third lens 300 facing away from the second lens 200 is convex. The light projected from the side surface of the third lens 300 facing the second lens 200 becomes parallel light after passing through the side surface of the third lens 300 facing away from the second lens 200.

According to reversibility of light, as shown in FIG. 20, FIG. 21, FIG. 25 and FIG. 29, the third lens 300 is capable of converging the parallel light into a plurality of first focal points 111 which are located on a first focal line 110. When observed along an optical axis direction, the light passing through the third lens 300 remains parallel in the first direction X (that is, when viewed from top). The second lens 200 is disposed on a side of the third lens 300, and the second lens 200 is capable of converging the light passing through the third lens 300 into a plurality of second focal points 211 (that is, the real focal point 400 of the lens assembly) which are located on a second focal line. When observed along the optical axis direction, the light passing through the second lens 200 remains parallel in the first direction X (that is, when viewed from top).

That is, the third lens 300 in the present application only focuses in the vertical direction, while the light remains parallel in the horizontal direction. That is, the plurality of first focal points 111 converge on one focal line, and the second lens 200 also focuses in the vertical direction, with the light remaining parallel in the horizontal direction. Moreover, the first focal point is the real focal point 400 of the lens assembly (external), and the plurality of second focal points converge on another focal line.

In the present application, the light is focused to form an image in the vertical direction, while the light remains unchanged in the horizontal direction, that is, no image is formed. The curved total reflection lens 700 makes the reflected light distribute in a crosswise pattern horizontally, that is, the curved total reflection lens 700 diverges the light pattern horizontally, that is, an edge of the curved total reflection lens 700 is a boundary line of a low bean pattern cutoff line. In addition, compared to a single-layer single focal point focusing lens in the conventional technologies, the present application adopts two lenses (the second lens 200 and the third lens 300) to achieve focusing, so that an overall thickness is less than the single focal point focusing lens, thereby reducing a weight.

Herein, the first inclined surface 102 is capable of mirroring the curved total reflection lens 700 into a virtual image 800, and the plurality of real focal points 400 (that is, a focal line) of the lens assembly are located at an edge of the virtual image 800, that is, they are located near the boundary, so that a good light pattern is formed, and the cutoff line has a good color which is close to no dispersion.

In the alternative embodiment of the present application, structures of the first lens 100 and the curved total reflection lens 700 may be the same as that in the embodiment mentioned above, which will not be described in detail herein. In addition, in the embodiments mentioned above, a tangent surface may also be additionally disposed between the first inclined surface 102 and the light incident surface 101.

According to the fourth aspect of the present application, a vehicle lamp is provided, which includes the optical lens module as described in any one of the embodiments above.

In addition, the vehicle lamp may also include a plurality of light sources 500 (for example, light-emitting diode (LED) lights) and a plurality of circuit boards. The plurality of light sources 500 are in one-to-one correspondence with the plurality of circuit boards, and the plurality of light sources 500 are in one-to-one correspondence with the plurality of curved total reflection lens 700. A long side of anyone of the plurality of circuit boards extends in a vertical direction, that is, the circuit board is vertically disposed and faces toward an optical axis direction. Such a layout ensures good thermal cycling of a module, thereby facilitating heat dissipation and being convenient for installing.

According to the optical lens module of the present application, which includes a first lens 100, a lens assembly and a curved total reflection lens 700. The lens assembly includes a second lens 200 and a third lens 300. The second lens 200 and the first lens 300 are integrally formed, and the third lens 300 is disposed on a side of the second lens 200. A real focal point of the lens assembly is located outside the second lens. A side of the first lens 100 facing away from the third lens 300 includes a light incident surface 101 and a first inclined surface 102 connected to each other. The curved total reflection lens 700 is disposed below the first inclined surface 102, and a side of the curved total reflection lens 700 facing away from the first inclined surface 102 is convex. A light emitted from an external light source of the present application is capable of entering through the light incident surface 102, being reflected by curved total reflection lens 700, and then being reflected by first inclined surface 102. The lens assembly projects the light reflected by the first inclined surface into parallel light, that is, the light reflected by the first inclined surface is projected into the parallel light by the lens assembly. An optical path of the present application is folded, so that a length of a module is shortened. Moreover, a final light pattern of the optical (low beam) lens module provided by the present application is an image of a light beam reflected by the curved total reflection lens, and an edge of the curved total reflection lens is a boundary line forming a cutoff line of a low beam pattern. Compared to a traditional lens structure, according to the present application, a good cutoff line color is form, which is close to no dispersion.

A fifth aspect of the present application provides a lens assembly, thereby solving problems that conventional focusing lenses are not suitable for design with a greater opening size or a long strip opening and is in poor controllability of low and high beams with a pattern which is flatter vertically and wider horizontally.

With development of vehicle lamp lighting technologies, low beam and high beam lens modules module for lighting have become increasingly popular, and a horizontal long strip module design has become one of the trends in the development of the industry. Before the present application is put forward, in the conventional technologies, a single-layer single focal point focusing lens is generally adopted. This traditional method is not suitable for designs with a greater opening size or long strip openings, because once a horizontal opening is relatively long, a thickness of the lens increases accordingly, and a weight thereof also increases, which contradict to a concept of lightweight, energy saving and cost-saving principles. In addition, the single-layer single-focus lens of the conventional technologies has same focused degrees o in horizontal and vertical directions, resulting in poor controllability of low and high beams with a pattern which is flatter vertically and wider horizontally.

In view of this, according to a fifth aspect of the present application, a lens assembly is provided. The lens assembly includes a third lens 300 and a second lens 200. The third lens 300 is capable of converging the parallel light to a plurality of first focal points 111 which are located on a first focal line110. When observed along an optical axis direction, a light passing through the third lens 300 remains parallel in a first direction X (that is, when viewed from top). The second lens 200 is disposed on a side of the third lens 300. The second lens 200 is capable of converging the light passing through the third lens 300 to a plurality of second focal points 211 which are located on a second focal line. When observed along the optical axis direction, a light passing through the second lens 200 is not parallel in the first direction X.

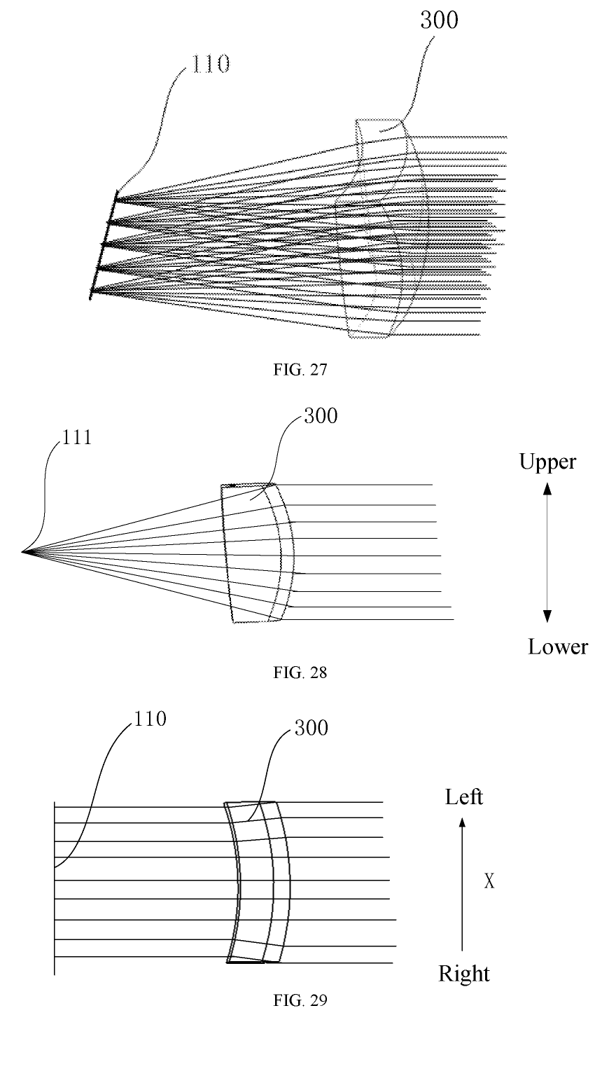

That is, the third lens 300 of the present application only focuses in the vertical direction (as shown in FIG. 28), while the light remains parallel in the horizontal direction (as shown in FIG. 29). That is, the plurality of first focal points 111 converge on one focal line (as shown in FIG. 26, FIG. 27, and FIG. 29). The second lens 200 focuses horizontally (as shown in FIG. 25), and a focal point (a second focal point 211) is adjustable (for example, by adjusting a curvature, distance, and the like). The plurality of second focal points 211 converge on another focal line (as shown in FIG. 24 and FIG. 25). Due to reversibility of light, on-site personnel may install a plurality of light sources as needed. The light emitted from anyone of the plurality of light sources is capable of diverging from the corresponding second focal point 211, and finally diverges into parallel light through the third lens 300. A vertical light of the present application has a longer focal length than a horizontal light (as shown in FIG. 24, a distance from the second focal point 211 to a side surface of the third lens 300 facing away from the second lens 200, that is, a distance from the second focal point 211 to the parallel light), which facilitates vertical convergence of high and low beam patterns. The horizontal light of the present application has a shorter focal length than the vertical light (as shown in FIG. 25, a distance from the second focal point 211 to a side surface of the second lens 200 facing the third lens 300, that is, a distance from the second focal point 211 to a horizontal parallel light), which facilitates horizontal widening of the high and low beam patterns, thereby satisfying design requirements. In addition, compared to the single-layer single focal point focusing lens in the conventional technologies, the present application adopts two lenses to achieve focusing, so that an overall thickness thereof is less than the single focal point focusing lens, and thus a weight thereof is also reduced. Specific structures of the third lens 300 and the second lens 200 will be described in detail below.

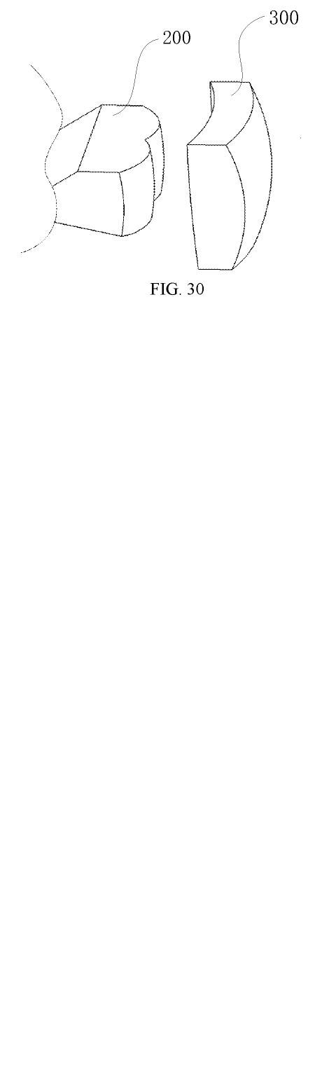

In the embodiment of the present application, as shown in FIG. 26, FIG. 27, and FIG. 30, a side surface of the third lens 300 facing the second lens 200 is concave along the optical axis, and a side surface of the third lens 300 facing away from the second lens 200 is convex along the optical axis. Herein, the description that a surface of the lens is convex along the optical axis means that a paraxial region of the corresponding surface is convex, and the description that a surface of the lens is concave along the optical axis means that a paraxial region of the corresponding surface is concave. Therefore, even when a surface of the lens is described as being convex, an edge portion of that surface of the lens may be concave. Similarly, even when a surface of the lens is described as being concave, an edge portion of that surface of the lens may be convex.

As an example, a front surface of the third lens 300 (the surface facing away from the second lens 200) may be a symmetric curved surface, a cylindrical surface, or an asymmetric inclined surface. A rear surface of the lens (the surface facing the second lens 200) is a freeform curved surface calculated based on the front surface. Regardless of the structure, the core feature is the focal line lens, that is, the parallel light in the optical axis direction converges into a straight line after passing through the lens.

In the embodiment of the present application, as shown in FIG. 26 and FIG. 27, schematic diagrams of an overall structure of the third lens 300 and a light path of examples according to the present application are shown. As shown in FIG. 28, a side view of the third lens 300 and the light path according to the embodiment of the present application is shown. As shown in FIG. 29, a top view of the third lens 300 and the light path according to the embodiment of the present application is shown.

In addition, since the third lens 300 of the present application is not a single focus point lens, this module solution avoids focusing the sunlight into a point or a cluster, which greatly reduces a risk that the sunlight burns a part of a vehicle lamp.

In the embodiment of the present application, the second lens 200 includes a plurality of real focal points, and the plurality of second focal points 211 coincide with the plurality of real focal points, that is, they coincide with each other in a one-to-one correspondence manner.

As an example, as shown in FIG. 30, an overall structural diagram of the lens assembly according to the embodiment of the present application is shown. As shown in FIG. 24, a side view of the lens module and a light path according to the embodiment of the present application is shown. As shown in FIG. 25, a top view of the lens module and a light path according to the embodiment of the present application is shown.

In the embodiment of the present application, as shown in FIG. 30, a side of the second lens 200 facing the third lens 300 includes a plurality of convex portions. A convex surface of anyone of the plurality of convex portions is convex along the optical axis, and anyone of the plurality of convex surfaces and the third lens 300 include one real focal point 400. Anyone convex surface is capable of converging the light passing through the third lens 300 to one of the second focal points 211. Herein, the description that a surface of a lens is convex along the optical axis means that a paraxial region of the corresponding surface is convex. Therefore, even when a surface of the lens is described as being convex, an edge portion of the surface of the lens may be concave.

In addition, as shown in FIG. 30, the second lens 200 also includes an inclined surface opposite to the convex surface and two side surfaces located on two sides thereof. The first direction X passes through the two side surfaces, and a curved edge is formed at a joint of an edge of anyone convex surface and the corresponding side surface. Herein, curvatures of the two curved edges may be set according to requirements.

That is to say, in the present embodiment, the second lens 200 is only one surface of a medium, and any convergence point (the second focus 211) is located in the medium, the parallel light, that is, the light in the vertical and horizontal directions converges at a real focal point in the medium of the second lens 200. In addition, the real focal point 400 of the second lens 200 coincides with or separate from a virtual focus, and the real focal point 400 is located in front of or behind the virtual focus, which may be set according to needs of the on-site personnel.

Herein, the first focal line110 and the second focal line are parallel to the first direction X, and the optical axis direction is perpendicular to the first direction X.

The lens assembly of the present application consists of two layers of lenses forming a confocal system to achieve projection imaging of high and low beam patterns, which presents an image of a light beam at the real focal point in the medium of the second lens.

According to the sixth aspect of the present application, a vehicle lamp is provided, which includes the lens assembly as described in the embodiment mentioned above.

The vehicle lamp also includes a plurality of light sources 500 and a first lens 100, and the plurality of light sources 500 are in one-to-one correspondence with the plurality of second focal points 211, and a light emitted from anyone light source is capable of diverging from the corresponding second focus point 211 after passing through the first lens 100. In this embodiment, as shown in FIG. 25 and FIG. 30, the light sources (for example, light-emitting diode (LED) light sources) may be two.

Furthermore, a light input and collection portions of the LED light source and the first lens (the first lens is not shown in the figure) may be integrated with the second lens to shorten a dimension chain.

According to the lens assembly of the present application, the lens assembly includes a third lens 300 and a second lens 200. The third lens 300 is capable of converging the parallel light to a plurality of first focal points 111, and the plurality of first focal points 111 are on a first focal line 110. When observed along an optical axis direction, a light passing through the third lens 300 remains parallel in a first direction X. The second lens 200 is disposed on a side of the third lens 300. The second lens 200 is capable of converging the light passing through the third lens 300 to a plurality of second focal points 211, and the plurality of second focal points 211 are on a second focal line. When observed along the optical axis direction, a light passing through the second lens 200 is not parallel in the first direction X.

That is, the third lens 300 of the present application only focuses in a vertical direction, and the light remains parallel in a horizontal direction, that is, the plurality of first focal points 111 converge on one focal line, the second lens 200 focuses horizontally, a position of the focal point (the second focal point 211) is adjustable (for example, by adjusting a curvature, distance, and the like), and the plurality of second focal points 211 converge on another focal line. Due to reversibility of light, on-site personnel may install the plurality of light sources as needed, and a light emitted from anyone of the plurality of light sources is capable of diverging from the corresponding second focal point, and eventually diverges into parallel light through the third lens. A vertical light of the present application has a longer focal length than a horizontal light (a distance from the second focal point to a side surface of the third lens facing away from the second lens, that is, a distance from the second focal point to the parallel light), which facilitates vertical convergence of high and low beam patterns. The horizontal light of the present application has a shorter focal length than the vertical light (a distance from the second focal point to a side surface of the second lens facing the third lens, that is, a distance from the second focal point to the horizontal parallel light), which facilitates horizontal widening of the high and low beam patterns, thereby satisfying design requirements.

In addition, compared to a single-layer single focal point focusing lens in the conventional technologies, the present application adopts two lenses to collectively complete focusing, so that an overall thickness thereof is less than that of the single focal point focusing lens, thereby reducing a weight thereof. It solves a problem that a size of the single focus point lenses is limited by the thickness and weight thereof, thereby satisfying the requirements of energy saving, emission reduction and cost reduction. Focus separation is achieved through a freeform curved surface technology, the thickness, volume, and weight of the lenses are significantly reduced, which conforms to the concept of energy saving and carbon neutrality.

Finally, it should be noted that the above-mentioned embodiments are only specific implementations of the present application, which are used for illustrating the technical solutions of the present application, and are not intended to limit them, so that the protection scope of the present application is not limited to this. Although the present application have been described in detail with reference to the foregoing embodiments, those with ordinary skill in the art should understand that any technical personnel familiar with this technical field can modify or readily conceive variations to the technical solutions recorded in the foregoing embodiments within the technical scope disclosed in the present application, or equivalently substitute some of the technical features; and these modifications, variations, or substitutions do not deviate from the spirit and scope of the technical solutions of the embodiments of the present application, and should be covered within the protection scope of the present application. Therefore, the protection scope of the present application should be subject to the protection scope defined by the claims.

What is claimed is:

1. A lens assembly, comprising a second lens and a third lens; wherein
the third lens is configured to converge a parallel light to a plurality of first focal points, the plurality of first focal points are on a first focal line, and when observed along an optical axis direction, a light passing through the third lens remains parallel in a first direction; and
the second lens is disposed on a side of the third lens, and the second lens is configured to converge the light passing through the third lens to a plurality of second focal points, the plurality of second focal points are on a second focal line, and when observed along the optical axis direction, the light passing through the second lens is not parallel in the first direction.

2. The lens assembly according to claim 1, wherein the first focal line and the second focal line are both parallel to the first direction, and the optical axis direction is perpendicular to the first direction.

3. The lens assembly according to claim 1, wherein the second focal line is located in the second lens.

4. The lens assembly according to claim 1, further comprising a plurality of real focal points, wherein the plurality of second focal points coincide with the plurality of real focal points.

5. The lens assembly according to claim 4, wherein a side of the second lens facing the third lens comprises a plurality of convex portions, a convex surface of anyone of the plurality of convex portions is convex along the optical axis, and the convex surface and the third lens comprise one real focal point;
the convex surface is configured to converge the light passing through the third lens to one second focal point;
the second lens further comprises an inclined surface opposite to the convex surface and two side surfaces located on two sides of the inclined surface, and a curved edge is formed at a joint of an edge of the convex surface and the side surface corresponding to the edge of the convex surface; and
a side surface of the third lens facing the second lens is concave along the optical axis, and a side surface of the third lens facing away from the second lens is convex along the optical axis.

6. A vehicle lamp, comprising the lens assembly according to claim 1.

7. An optical lens module, comprising a first lens, the lens assembly according to claim 1, and a curved total reflection lens, wherein
the second lens is integrally formed with the first lens, the third lens is disposed on a side of the second lens, and a real focal point of the lens assembly is located in the second lens;
a side of the first lens facing away from the third lens comprises a light incident surface and a first inclined surface connected to each other, the curved total reflection lens is disposed below the first inclined surface, and a side of the curved total reflection lens facing away from the first inclined surface is convex; and
a light emitted from an external light source is capable of entering through the light incident surface, being reflected by the curved total reflection lens and the first inclined surface, then converging at the real focal point, and then being projected by the lens assembly into a parallel light after passing through the real focal point.

8. The optical lens module according to claim 7, wherein the lens assembly comprises a plurality of the real focal points and a plurality of the curved total reflection lenses;
the plurality of curved total reflection lenses are disposed below the first inclined surface, and the plurality of curved total reflection lenses are in one-to-one correspondence with the plurality of real focal points; and
the light emitted from the external light source is capable of entering through the light incident surface, being reflected by the curved total reflection lens and the first inclined surface, then converging at the real focal point corresponding to the curved total reflection lens, and then being projected by the lens assembly into the parallel light after passing through the real focal point.

9. The optical lens module according to claim 8, wherein, a side of the second lens facing the third lens comprises a plurality of convex portions, a convex surface of any one of the plurality of convex portions is convex along an optical axis, any one of the plurality of convex portions and the third lens collectively comprise one of the real focal points, and the plurality of convex portions are in one-to-one correspondence with the plurality of curved total reflection lenses;
when observed along an optical axis direction, the light diverging from the real focal point remains parallel in the first direction after passing through the convex portion corresponding to the real focal point, and the optical axis direction is perpendicular to the first direction; and
a side surface of the third lens facing the second lens is concave along the optical axis;
when observed along the optical axis direction, the light passing through the side surface of the third lens facing the second lens remains parallel in the first direction;
a side surface of the third lens facing away from the second lens is convex along the optical axis; and
the light projected from the side surface of the third lens facing the second lens and passing through the side surface of the third lens facing away from the second lens is the parallel light.

10. The optical lens module according to claim 9, wherein the first lens further comprises a second inclined surface, a third inclined surface and a vertical plane, and the light incident surface, the first inclined surface, the third inclined surface, the second inclined surface and the vertical plane are sequentially connected;
the light incident surface extends in a vertical direction, and the first inclined surface is at a first angle relative to the light incident surface and extends toward the second lens;
the second inclined surface is at a second angle relative to the light incident surface and extends toward the second lens, the third inclined surface is at a third angle relative to the second inclined surface and faces away from the first inclined surface, and the vertical plane is parallel to the light incident surface; and
an edge of each of the plurality of curved total reflection lenses is connected to the second inclined surface, the third inclined surface and the vertical plane.

11. The optical lens module according to claim 10, wherein, any one of the plurality of curved total reflection lenses comprises two side edges opposite to each other and two curved edges opposite to each other, the two side edges are both connected to the second inclined surface, and the two curved edges are respectively connected to the third inclined surface and the vertical plane;
the second lens further comprises two side surfaces, the two side surfaces are opposite to each other in the first direction, and a curved edge is formed at a joint of an edge of any one of the plurality of convex surfaces and the side surface corresponding to the edge of any one of the plurality of convex surfaces; and
sizes of the light incident surface and the vertical plane in the vertical direction are both greater than a size of the curved edge connected to the vertical plane in the vertical direction.

12. The optical lens module according to claim 7, wherein the first inclined surface is configured to mirror the curved total reflection lens into a virtual image, and a convergence point of the virtual image coincides with the real focal point of the lens assembly.

13. A vehicle lamp, comprising the optical lens module according to claim 7.

14. An optical lens module, comprising a first lens, the lens assembly according to claim 1 and a curved total reflection lens, wherein
the lens assembly comprises a second lens and a third lens, the second lens is integrally formed with the first lens, the third lens is disposed on a side of the second lens, and a real focal point of the lens assembly is located outside the second lens;
a side of the first lens facing away from the third lens comprises a light incident surface and a first inclined surface connected to each other, the curved total reflection lens is disposed below the first inclined surface, and a side of the curved total reflection lens facing away from the first inclined surface is convex;
a light emitted from an external light source is capable of entering through the light incident surface, being reflected by the curved total reflection lens, and then being reflected by the first inclined surface; and
the lens assembly is configured to project the light reflected by the first inclined surface into a parallel light.

15. The optical lens module according to claim 14, wherein the optical lens module comprises a plurality of the curved total reflection lenses, a side of the second lens facing the third lens is provided with a plurality of convex portions, a convex surface of any one of the plurality of convex portions is convex along an optical axis, and the plurality of convex portions are in one-to-one correspondence with the plurality of curved total reflection lenses; and
the light emitted from an external light source is capable of entering through the light incident surface, being reflected by the corresponding curved total reflection lens, and then being reflected by the first inclined surface; and when observed along an optical axis direction, the light reflected by the first inclined surface remains parallel in the first direction after passing through the convex portion corresponding the curved total reflection lens, and the optical axis direction is perpendicular to the first direction.

16. The optical lens module according to claim 15, wherein a side surface of the third lens facing the second lens is concave along the optical axis;
when observed along the optical axis direction, the light projected from any one of the plurality of convex portions remains parallel in the first direction after passing through the side surface of the third lens facing the second lens;
a side surface of the third lens facing away from the second lens is convex; and
the light projected from the side surface of the third lens facing the second lens and passing through the side surface of the third lens facing away from the second lens is the parallel light.

17. The optical lens module according to claim 14, wherein the optical lens module comprises a plurality of the curved total reflection lenses, and the light emitted from the external light source is capable of entering through the light incident surface, being reflected by the plurality of curved total reflection lenses, and then being reflected by the first inclined surface; and
when observed along an optical axis direction, the light reflected by the first inclined surface remains parallel on a first direction after passing through a side surface of the second lens facing the third lens.

18. The optical lens module according to claim 17, wherein a side surface of the third lens facing the second lens is concave along an optical axis;
when observed along the optical axis direction, the light projected from the side surface of the second lens facing the third lens remains parallel in the first direction after passing through the side surface, facing the second lens, of the third lens;
a side surface of the third lens facing away from second lens is convex; and
the light projected from the side surface of the third lens facing the second lens and passing through the side surface of the third lens facing away from the second lens is the parallel light.

19. The optical lens module according to claim 14, wherein the first lens further comprises a second inclined surface, a third inclined surface and a fourth inclined surface; and the light incident surface, the first inclined surface, the third inclined surface, the second inclined surface and the fourth inclined surface are sequentially connected;
the light incident surface extends in a vertical direction, the first inclined surface is at a first angle relative to the light incident surface and extends toward the second lens, the fourth inclined surface is at a second angle relative to the light incident surface and extends toward the first inclined surface, the second inclined surface is at a third angle relative to the fourth inclined surface and extends toward the second lens, and the third inclined surface is at a fourth angle relative to the second inclined surface and extends away from the first inclined surface;
any one of the curved total reflection lenses comprises two side edges and a curved edge connected to each other, and the curved edge is connected to the third inclined surface;
the two side edges are both connected to the fourth inclined surface;
widths of the two side edges gradually decrease from top to bottom;
the first lens further comprises a vertical plane, the vertical plane is connected to the fourth inclined surface, and the vertical plane is parallel to the light incident surface; and
the first inclined surface is configured to mirror the curved total reflection lens into a virtual image, and the real focal point of the lens assembly is located at an edge of the virtual image.

20. A vehicle lamp, comprising the optical lens module according to claim 14.
